(19) United States
(12) Patent Application Publication
(10) Pub. No.: US 2026/0342268 A1
(43) Pub. Date: Oct. 29, 2026

(54) ELECTROMECHANICAL DRIVE FOR ACTUATING A SASH MOUNTED MOVEABLY ON A STRUCTURE ELEMENT

(71) Applicant: DORMAKABA DEUTSCHLAND GMBH, Ennepetal (DE)

(72) Inventor: Dennis BÖSE, Ennepetal (DE)

(21) Appl. No.: 19/117,887

(22) PCT Filed: Oct. 5, 2023
(86) PCT No.: PCT/EP2023/077635

§ 371 Date: Apr. 2, 2025

(30) Foreign Application Priority Data
Oct. 7, 2022 (EP) 22200311.3

(51) Int. Cl. H02P 29/024; H02K 7/14; H02P 3/02

(52) U.S. Cl. CPC H02P 29/024; H02K 7/14; H02P 3/02

(57) ABSTRACT

An electromechanical drive for actuating a leaf, movably supported on a structural element. The electromechanical drive has an electric motor with at least one phase, a voltage curve across this phase is continuous during electric motor operation. A drive shaft of the electric motor is operatively connected to the leaf via a power transmission device when the electromechanical drive is mounted on the leaf and/or the frame as intended whereby a movement of the drive shaft causes a movement of the leaf. The electromechanical drive has a mechanical energy storage device, charged by an opening movement of the leaf and discharged by a closing movement of the leaf whereby the closing movement is triggered and/or supported by the energy stored in the mechanical energy storage device. The electromechanical drive has an emergency brake device by which the movement of the leaf is braked in an operating state suitable for emergencies.

### CROSS-REFERENCE TO RELATED APPLICATIONS

This application is a 35 U.S.C. § 371 National Stage patent application of PCT/EP 2023/077635, filed on 5 Oct. 2023, which claims the benefit of European patent application 22200311.3, filed on 7 Oct. 2022, the disclosures of which are incorporated herein by reference in their entirety.

### TECHNICAL FIELD

The disclosure relates to an electromechanical drive for actuating a leaf, in particular a door leaf or a window leaf, movably supported on a structural element with the electromechanical drive having an electric motor with at least one phase, with a voltage curve across this phase being continuous during operation of the electric motor, with a drive shaft of the electric motor being operatively connected to the leaf via a power transmission device, when the electromechanical drive is mounted on the leaf and/or the frame as intended such that a movement of the drive shaft causes a movement of the leaf, with the electromechanical drive having a mechanical energy storage device which is charged by an opening movement of the leaf and discharged by a closing movement of the leaf such that the closing movement is triggered and/or supported by the energy stored in the mechanical energy storage device.

### BACKGROUND

Electromechanical drives for moving a leaf are known from the prior art. A leaf is in particular understood to be a door or window leaf. Leaves of this type are supported in the structural elements surrounding the leaf, such as frames. The leaf therefore represents the moving part and the structural element the fixed part. The term frame can therefore also refer to any other structural element surrounding the leaf, in particular a building wall.

Electromechanical drives of this type often have an electric motor and a mechanical closing unit. The mechanical closing unit can be a spring, for example, which is tensioned by the electric motor when the leaf is opened or when the leaf is moved in an opening direction. The energy stored in the spring is used to close the leaf. During the closing process, the electric motor can be used to brake the movement of the leaf.

The leaf should also be reliably braked in the event of a fault and in particular in the event of a power failure. This applies not only to the closing process, but also to the manually performed opening process in the event of a fault, in order to prevent an uncontrolled impact in the opening end position.

In order to be able to use the electric motor for braking in the event of a fault, it is known to short-circuit phases of the electric motor, for example via diodes. If the electric motor rotates with the short-circuited phase, a voltage is induced, with the current flowing via the phase causing a braking torque. In this way, the electric motor can be used as a brake in generator operation. It is known from publication EP 2 267 881 A2 that the energy generated by the generator is fed to a bipolar transistor as a load resistor. It is known from publication EP 3 245 732 B1 to control the phase short-circuit in a pulse-width modulated way in such manner that a predefined current flow through the motor coils and thus a predefined braking torque results.

To control the braking effect in the event of a fault, it is necessary to provide electrical energy to operate the control electronics. This can take place using suitable batteries, for example. However, it must always be ensured that the batteries are sufficiently charged to enable operation of the control electronics. In addition, longer operation in the event of a fault cannot be guaranteed in this way, as the batteries only have a limited capacity.

### SUMMARY

The disclosure further develops the electromechanical drives known from the prior art such that safe operation is possible in the event of a fault.

This advantage is achieved according to the disclosure by providing that the electromechanical drive has an emergency brake device, by way of which the movement of the leaf can be braked in an operating state suitable for emergencies, by the electric motor being operated as a generator, with a movement-dependent voltage being applied in each case between phase terminals of the electric motor operated as a generator as a result of the movement of the leaf, with the phase terminals being connected in an electrically conductive manner to a brake circuit of the emergency brake device, with the emergency brake device having a control energy generating device, with the control energy generating device generating electrical energy for the operation of a control device of the emergency brake device, which controls the brake circuit, from an electrical current flowing between the phase terminals, with the control energy generating device being connected in an electrically conductive manner to the control device, with the brake circuit having a current control device by way of which a current flow through the brake circuit and thereby between the phase terminals can be adjusted, and with the control device being connected in an electrically conductive manner to the current control device to predefine the braking effect exerted by the emergency brake device on the leaf. The emergency brake device is configured in such manner that the control device is supplied with electrical energy from the electrical energy generated by the movement of the leaf as a generator, particularly in the event of a power failure. In this way, when the leaf moves, the control device can activate the current control device of the brake circuit such that a desired maximum braking effect is achieved by adjusting the current flowing between the phase terminals of the electric motor. If the leaf does not move, there is no voltage applied between the phase terminals such that the power generating device cannot provide any electrical energy for operating the control device and the control device cannot be operated. However, as the control device is only intended and required for the controlled braking process, this is not a disadvantage.

According to the disclosure, it is advantageously provided that the electric motor is a three-phase or alternating current electric motor, with the brake circuit having a brake rectifier circuit, with the brake rectifier circuit being connected in an electrically conductive manner to the phase terminals of the electric motor operated as a generator. In generator operation, the alternating current or three-phase electric motor generates a single-phase or multi-phase electrical alternating voltage between the phase terminals of the electric motor assigned to one another. By rectifying this possibly multi-phase alternating voltage through the brake rectifier circuit, the braking or short-circuit current flowing via the brake circuit between the phase terminals can be adjusted particularly easily, for example by using a MOSFET in the brake circuit in accordance with the disclosure.

Advantageously, it is provided according to the disclosure that the control energy generating device has a control rectifier circuit, with the control rectifier circuit being connected in an electrically conductive manner to the phase terminals of the electric motor operated as a generator. The electrical energy for operating the control device can be generated particularly easily directly via the control rectifier circuit from the electrical voltage applied between the phase terminals. A direct electrical voltage is advantageous for the operation of the control device, as this can be used to operate conventional electronic circuit elements such as microcontrollers. As the control rectifier circuit rectifies the alternating voltage applied between the phase terminals, the electrical energy provided by the control rectifier circuit can be made available directly to other electronic circuit components. When using a direct current motor, the control rectifier circuit is configured such that a voltage polarity of the movement-dependent voltage between the phase terminals that is dependent on the direction of movement of the leaf is rectified for operation of the control device.

Advantageously, it is provided according to the disclosure that the control rectifier circuit and the brake rectifier circuit are connected in an electrically conductive manner to the phase terminals in parallel to one another. By using the brake rectifier circuit and the control rectifier circuit, the respective advantages can be combined. When configuring the brake rectifier circuit and the control rectifier circuit, it is only necessary to ensure that sufficient electrical energy can be made available to the control device by the control rectifier circuit in every operating state of the brake circuit.

A particularly simple design of the brake rectifier circuit or the control rectifier circuit can be achieved by configuring the control rectifier circuit and/or the brake rectifier circuit as a bridge rectifier circuit. The bridge rectifier circuit is also known as a two-pulse bridge rectifier circuit and has two pairs of diodes connected in parallel. The phase terminals are connected in an electrically conductive manner to the bridge rectifier circuit between the diode pairs.

In order to ensure that sufficient electrical energy can be made available to the control device by the control rectifier circuit in every operating state of the brake current circuit, it is provided according to the disclosure that a design of the control rectifier circuit and a design of the brake rectifier circuit are identical. In this context, “identical” means that an identical design of the rectifier circuits is selected with components that have at least very similar characteristics. If bridge rectifier circuits are used, the diodes used should have similar properties as far as possible.

A maximum braking effect is achieved by the electric motor if the braking current flowing between the phase terminals is not limited by the current control device. This corresponds to a hard phase short circuit. In this case, an output voltage via the brake rectifier circuit is approximately 0 V. When using bridge rectifiers, for example, a voltage drop across the diodes of the brake rectifier circuit is relatively large in this case due to the high braking current. If diodes with a similar characteristic to the brake rectifier circuit are used for the control rectifier circuit, and if the current flowing through the control device is lower than the braking current flowing through the brake rectifier circuit, the voltage drop across the diodes of the control rectifier circuit is also lower. This voltage difference can be used as the output voltage of the control rectifier circuit for the control device.

Alternatively or in addition to using a control rectifier circuit, it is advantageously provided that the control energy generating device has a voltage drop element, with the voltage drop element being connected in an electrically conductive manner to the brake rectifier circuit and the current control device, with the control device being connected in an electrically conductive manner to the brake rectifier circuit and the current control device in parallel to the voltage drop element. The voltage drop element can, for example, be an ohmic resistor element with a predefined electrical resistor that is connected in series to the brake rectifier circuit and the current control device. As soon as current flows through the current control device, a current-dependent, defined voltage drops across the resistor element and can be used to supply the control device.

Advantageously, it is provided according to the disclosure that the control energy generating device is connected in an electrically conductive manner to the current control device in a parallel circuit. Depending on the configuration of the current control device, the current control device already contains electrical elements via which a voltage drop is generated that can be used to operate the control device. For example, a current measuring resistor can advantageously be provided in the current control device and can also be used as a voltage drop element.

In order to be able to supply the control device with sufficient electrical energy at all times and thus to be able to activate the current control device, it is advantageously provided when using a voltage drop element that the current control device is configured such that a current flow via the brake rectifier circuit and the current control device is greater than a current flow minimum at all times when the leaf moves. As a result, an electric current flows through the brake circuit at all times when the leaf moves and can provide sufficient energy to operate the control device via the voltage drop element.

Advantageously, it is provided according to the disclosure that the control device has a central control unit. The central control unit is advantageously an electronic and particularly advantageously a digital-electronic data processing device. According to the disclosure, a microcontroller is advantageously used as the central control device. Microcontrollers provide electrical inputs and outputs with digital-to-analogue and analogue-to-digital converters, PWM outputs and comparator inputs such that a microcontroller can simultaneously perform the necessary calculations, generate the electrical signals for activating the current control device and process measurement signals.

Advantageously, it is provided according to the disclosure that the current control device comprises a transistor, a current measuring element and a regulating element, with the transistor being connected in an electrically conductive manner to the brake rectifier circuit via a collector and an emitter, with a current flowing through the transistor being measured by the current measuring element, and with the regulating element being connected in an electrically conductive manner to a base of the transistor to predefine the current flow through the transistor, with the regulating element being connected in an electrically conductive manner to the central control unit of the control device, with the control device predefining a current setpoint value for the regulating element, with the regulating element being connected in an electrically conductive manner to the current measuring element, with the regulating element limiting a current flow such that the current setpoint value and the current coincide.

The transistor is preferably a MOSFET. A shunt resistor can advantageously be used as the current measuring element. An operational amplifier can advantageously be used as the regulating element. The operational amplifier compares the current value flowing through the MOSFET and the shunt resistor with a current setpoint value predefined by the control device. If the current flowing is too high, the gate voltage of the MOSFET is reduced by the operational amplifier until the current setpoint value is reached. If the current flowing is too low, the gate voltage of the MOSFET is increased by the operational amplifier until the current setpoint value is reached. The MOSFET is therefore used in linear operation. This circuit generates a constant load current between the phase terminals, provided the electric motor can deliver this. Otherwise, the load current is limited by the maximum current flow that can be generated by the electric motor.

Advantageously, it is provided according to the disclosure that a level converter is arranged between the central control unit and the regulating element.

In particular when using a control rectifier circuit, a low potential of the brake rectifier circuit moves away from a reference potential used for control as the braking current increases. The voltage difference between these potentials can influence the current control device such that without an additional circuit section, the effective current setpoint value predefined by the control device would be dependent on the braking current and regulation would not be possible. The level converter can be used to convert the current setpoint value generated by the control device or the actuating voltage used for control into a differential output voltage such that the actuating voltage of the regulating element is independent of the braking current.

Advantageously, it is provided according to the disclosure that the control device has an overvoltage protector, with the overvoltage protector being directly connected in an electrically conductive manner to the control energy generating device. For example, when using a control rectifier circuit with an unbraked electric motor, an output voltage of the control rectifier circuit could correspond to the open-circuit voltage of the electric motor. Depending on the configuration of the electric motor, this output voltage could be too high for the operation of the control unit and damage it. Overvoltage protector makes it possible to limit the output voltage generated by the control power generating device to a range that is safe for the operation of the control device.

Advantageously, it is provided according to the disclosure that the control device has a voltage regulator, with the voltage regulator being connected in an electrically conductive manner to the current control device and supplying the current control device with electrical energy and with the voltage regulator being connected in an electrically conductive manner to further components of the control device and supplying these with electrical energy. The output voltage generated by a control rectifier circuit, for example, is too low for the operation of the control device in many applications. By using the voltage regulator, which can be configured as a switching regulator, for example, an operating voltage sufficient for the operation of the control device can be generated from the output voltage.

In order to generate an operating voltage that is sufficiently precise for the operation of the central control unit, it is provided according to the disclosure that the control device has a linear regulator, with the linear regulator being arranged in an electrically conductive manner between the voltage regulator and the other components of the control device.

Advantageously, it is provided according to the disclosure that the control device has a measuring device for recording the speed of movement and the direction of movement of the leaf. The measuring device can advantageously include Hall sensors for recording rotary movement parameters of the electric motor. These can advantageously be processed by the central control unit. When using a microcontroller as a central control device, the existing inputs of the microcontroller can be used for this purpose.

Advantageously, it is provided according to the disclosure that the electric motor is an axial flux motor or a radial flux motor. Axial or a radial flux machines are particularly suitable for use with door or window drives.

In a particularly advantageous configuration of the electromechanical drive according to the disclosure it is provided that the electromechanical drive consists of the three-phase motor and the emergency brake device, with the emergency brake device consisting of the control energy generating device, the control device and the brake circuit, with the control energy generating device consisting of the control rectifier circuit, with the control device consisting of the regulating element, the level converter, the overvoltage protector, the voltage regulator, the linear regulator, the measuring device and the central control unit, with the brake circuit consisting of the current control device and the brake rectifier circuit, and with the current control device consisting of the transistor, the current measuring element and the regulating element.

### BRIEF DESCRIPTION OF THE DRAWINGS

Further advantageous configurations of the electromechanical drive according to the disclosure are explained in more detail with reference to exemplary embodiments represented in the drawing, in which is shown:

FIG. 1 a schematically represented sectional view of an electromechanical drive with an emergency brake device, and

FIG. 2 a circuit diagram of the emergency brake device.

### DETAILED DESCRIPTION OF THE DRAWINGS

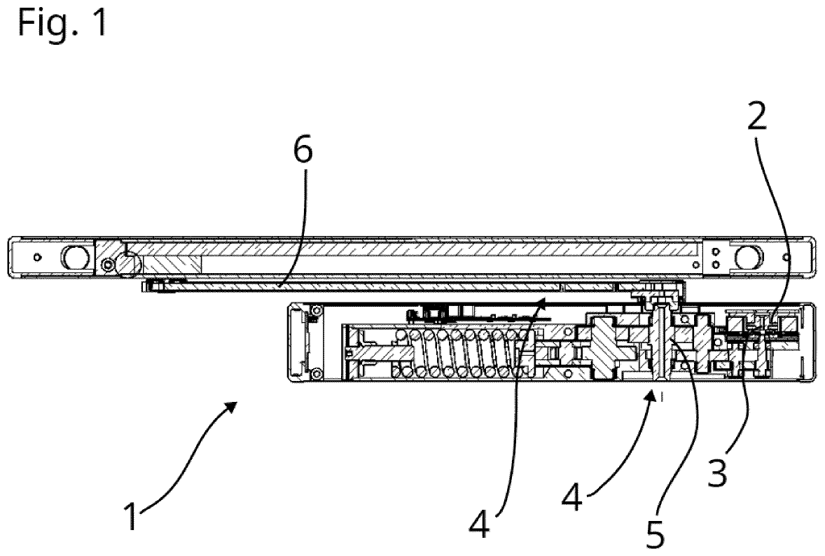

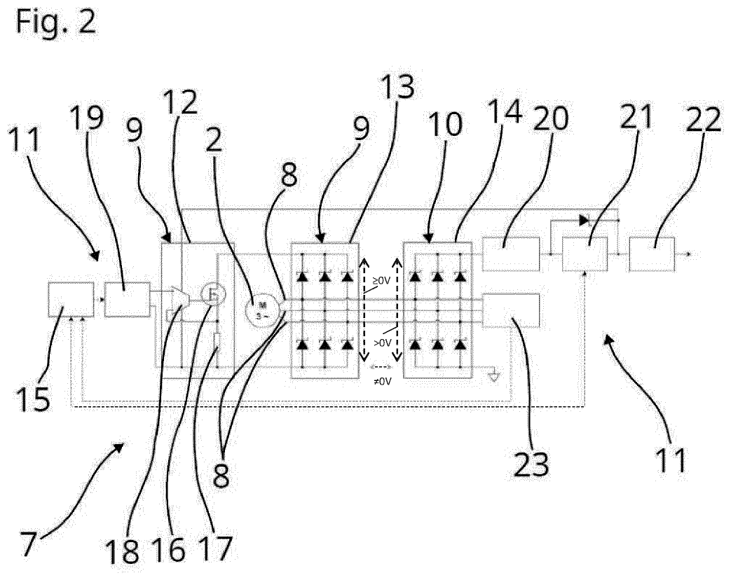

FIG. 1 schematically represents a sectional view of an electromechanical drive 1 for actuating a leaf, in particular a door leaf or a window leaf, mounted rotatably and/or displaceably on a structural element. The electromechanical drive 1 has a three-phase motor 2, which is configured as an axial flux machine. A drive shaft 3 of the three-phase motor 2 is operatively connected to the leaf, not represented, via a power transmission device 4. The power transmission device 4 substantially consists of a gearbox 5, which is connected to the three-phase motor 2, and a lever 6. This converts a movement of the drive shaft 3 during motor operation of the three-phase motor 2 into a movement of the leaf. A movement of the leaf in generator operation of the three-phase motor 2 causes a movement of the drive shaft 3 via the power transmission device 4. The electromechanical drive 1 also has an emergency brake device 7, which is not discernible in FIG. 1 but is represented in detail in FIG. 2.

The emergency brake device 7 can be used to brake the movement of the leaf in an operating state suitable for emergencies by operating the three-phase motor 2 as a generator. Due to the movement of the leaf, a movement-dependent voltage is applied between phase terminals 8 of the three-phase motor 2, which is operated as a generator. The phase terminals 8 are connected in an electrically conductive manner to a brake circuit 9 of the emergency brake device 7.

The emergency brake device 7 has a control energy generating device 10. The control energy generating device 10 generates electrical energy for the operation of a control device 11 of the emergency brake device 7, which controls the brake circuit 9, from an electrical current flowing between the phase terminals 8. The control energy generating device 10 is connected in an electrically conductive manner to the control device 11.

The brake circuit 9 has a current control device 12, which can be used to adjust a current flow through the brake circuit 9 and thereby between the phase terminals 8. The control device 11 is connected in an electrically conductive manner to the current control device 12 in order to predefine the braking effect exerted on the leaf by the emergency brake device 7. The brake circuit 9 also has a brake rectifier circuit 13 configured as a bridge rectifier circuit. The brake rectifier circuit 13 is connected in an electrically conductive manner to the phase terminals 8 of the three-phase motor 2, which is operated as a generator.

The control energy generating device 10 has a control rectifier circuit 14, also configured as a bridge rectifier circuit. The control rectifier circuit 14 is also connected in an electrically conductive manner to the phase terminals 8 of the three-phase motor 2, which is operated as a generator, in parallel to the brake rectifier circuit 13.

The control device 11 has a central control unit 15. The central control unit 15 is a microcontroller.

The current control device 12 comprises a transistor 16 configured as a MOSFET, a current measuring element 17 configured as a shunt resistor and a regulating element 18 configured as an operational amplifier. The transistor 16 is connected in an electrically conductive manner to the brake rectifier circuit 13 via a collector and an emitter.

The regulating element 18 is connected in an electrically conductive manner to a base of the transistor 16 to predefine the current flow through the transistor 16. The regulating element 18 is also connected in an electrically conductive manner to the central control unit 15 of the control device 11. The control device 11 predefines a current setpoint value for the regulating element 18.

The regulating element 18 is also connected in an electrically conductive manner to the current measuring element 17. A current flowing through the transistor 16 is measured by the current measuring element 17. The regulating element 18 limits a current flow between the phase terminals 8 such that the current setpoint value and the current flow coincide.

A level converter 19 is arranged between the central control unit 15 and the regulating element 18. The control device 11 also has an overvoltage protector 20, which is directly connected in an electrically conductive manner to the control power generating device 10. The control device 13 also has a voltage regulator 21 and a linear regulator 22, which are connected in an electrically conductive manner to the current control device 12 and supply the current control device 12 with electrical energy. The control device 11 also has a measuring device 23 to record the speed of movement and direction of movement of the leaf.

1. An electromechanical drive for actuating a leaf, movably supported on a structural element, the electromechanical drive comprising: an electric motor with at least one phase, wherein a voltage curve across this phase is continuous during operation of the electric motor, wherein a drive shaft of the electric motor is operatively connected to the leaf via a power transmission device when the electromechanical drive is mounted on the leaf and/or the frame as intended such that a movement of the drive shaft causes a movement of the leaf, wherein the electromechanical drive has a mechanical energy storage device, which is charged by an opening movement of the leaf and discharged by a closing movement of the leaf such that the closing movement is triggered and/or supported by the energy stored in the mechanical energy storage device, characterised in that the electromechanical drive has an emergency brake device, by way of which the movement of the leaf is configured to be braked in an operating state suitable for emergencies, by the electric motor being operated as a generator, wherein a movement-dependent voltage is applied between phase terminals of the electric motor operated as a generator as a result of the movement of the leaf, wherein the phase terminals are connected in an electrically conductive manner to a brake circuit of the emergency brake device, wherein the emergency brake device has a control energy generating device, wherein the control energy generating device generates electrical energy for the operation of a control device of the emergency brake device, which controls the brake circuit, from an electrical current flowing between the phase terminals, wherein the control energy generating device is connected in an electrically conductive manner to the control device, wherein the brake circuit comprises a current control device by way of which a current flow through the brake circuit and thereby between the phase terminals is configured to be adjusted, and wherein the control device is connected in an electrically conductive manner to the current control device to predefine the braking effect exerted by the emergency brake device on the leaf, wherein the electric motor is a three-phase or an alternating current electric motor, wherein the brake circuit has a brake rectifier circuit, wherein the brake rectifier circuit is connected in an electrically conductive manner to the phase terminals of the electric motor operated as a generator, and wherein the control energy generating device has a control rectifier circuit, wherein the control rectifier circuit is connected in an electrically conductive manner to the phase terminals of the electric motor operated as a generator.

2. (canceled)

3. (canceled)

4. The electromechanical drive according to claim 1, wherein the control rectifier circuit and the brake rectifier circuit are connected in an electrically conductive manner to the phase terminals in parallel to one another.

5. The electromechanical drive according to claim 1, wherein the control rectifier circuit and/or the brake rectifier circuit are configured as a bridge rectifier circuit.

6. The electromechanical drive according to claim 1, wherein a design of the control rectifier circuit and a design of the brake rectifier circuit are identical.

7. The electromechanical drive according to claim 1, wherein the control energy generating device has a voltage drop element, wherein the voltage drop element is connected in an electrically conductive manner to the brake rectifier circuit and the current control device wherein the control device is connected in an electrically conductive manner to the brake rectifier circuit and the current control device in parallel to the voltage drop element.

8. The electromechanical drive according to claim 7, wherein the control energy generating device is connected in an electrically conductive manner to the current control device in a parallel circuit.

9. The electromechanical drive according to claim 7, wherein the current control device is configured such that a current flow via the brake rectifier circuit and the current control device is greater than a current flow minimum at all times when the leaf moves.

10. The electromechanical drive according to claim 1, wherein the control device has a central control unit.

11. The electromechanical drive according to claim 1, wherein the current control device comprises a transistor, a current measuring element and a regulating element, wherein the transistor is connected in an electrically conductive manner to the brake rectifier circuit via a collector and an emitter, wherein a current flowing through the transistor is measured by the current measuring element, and wherein the regulating element is connected in an electrically conductive manner to a base of the transistor to predefine the current flow through the transistor, wherein the regulating element is connected in an electrically conductive manner to the central control unit of the control device, wherein the control device predefines a current setpoint value for the regulating element, wherein the regulating element is connected in an electrically conductive manner to the current measuring element, wherein the regulating element limits a current flow such that the current setpoint value and the current coincide.

12. The electromechanical drive according to claim 11, wherein a level converter is arranged between the central control unit and the regulating element.

13. The electromechanical drive according to claim 1, wherein the control device has an overvoltage protector, wherein the overvoltage protector is directly connected in an electrically conductive manner to the control energy generating device.

14. The electromechanical drive according to claim 1, wherein the control device has a voltage regulator, wherein the voltage regulator is connected in an electrically conductive manner to the current control device and supplies the current control device with electrical energy and wherein the voltage regulator is connected in an electrically conductive manner to further components of the control device and supplies these with electrical energy.

15. The electromechanical drive according to claim 14, wherein the control device has a linear regulator, wherein the linear regulator is arranged in an electrically conductive manner between the voltage regulator and the other components of the control device.

16. The electromechanical drive according to claim 1, wherein the control device has a measuring device for recording the speed of movement and the direction of movement of the leaf.
